(19) United States
(12) Patent Application Publication
(10) Pub. No.: US 2025/0189735 A1
(43) Pub. Date: Jun. 12, 2025

(54) OPTICAL DEVICE AND OPTICAL TRANSCEIVER

(71) Applicant: FURUKAWA ELECTRIC CO., LTD., Tokyo (JP)

(72) Inventors: Yuta ISHIGE, Tokyo (JP); Kazuya NAGASHIMA, Tokyo (JP); Hideyuki NASU, Tokyo (JP)

(73) Assignee: FURUKAWA ELECTRIC CO., LTD., Tokyo (JP)

(21) Appl. No.: 19/061,282

(22) Filed: Feb. 24, 2025

Related U.S. Application Data
(63) Continuation of application No. PCT/JP2023/033251, filed on Sep. 12, 2023.

(30) Foreign Application Priority Data
Sep. 30, 2022 (JP) 2022-158366

(51) Int. Cl. G02B 6/42; G02B 6/43

(52) U.S. Cl. CPC G02B 6/423; G02B 6/4212; G02B 6/4245; G02B 6/4246; G02B 6/4269; G02B 6/4284; G02B 6/43; G02B 6/428

(57) ABSTRACT

An optical device includes: a first substrate including a first surface facing a first direction and intersecting with the first direction; an optical transceiver provided to be shifted from the first substrate in the first direction; a socket positioned between the first substrate and the optical transceiver and including a plurality of connection conductors electrically connecting a conductor of the first substrate and a conductor of the optical transceiver, and an insulator supporting the plurality of connection conductors; and a positioning pin extending in the first direction between the first substrate and the optical transceiver and penetrating the socket, the positioning pin being configured to position the first substrate, the optical transceiver, and the socket in a direction intersecting with the first direction.

This application is a continuation of International Application No. PCT/JP2023/033251, filed on Sep. 12, 2023 which claims the benefit of priority of the prior Japanese Patent Application No. 2022-158366, filed on Sep. 30, 2022, the entire contents of which are incorporated herein by reference.

### BACKGROUND

The present disclosure relates to an optical device and an optical transceiver.

In the related art, as an optical transceiver used in a network switch device, a small optical transceiver disclosed in JP 2020-27147 A is known (for example, JP 2020-27147 A).

### SUMMARY

In a network switch device that implements co-packaged optics (CPOs), a switch application specific integrated circuit (ASIC) and a plurality of optical transceivers are mounted on a substrate.

With a rapid increase in data center traffic, it is urgently necessary to realize high capacity and low power consumption of the network switch device. In an architecture using an existing pluggable transceiver, the number of transceivers connected to a front panel of a switch device is rate-limiting, and a limit of an increase in capacity is seen. Therefore, there is a demand for a compact optical transceiver such as an ultra-compact co-packaged optics (CPO) optical transceiver disposed in the vicinity of the LSI. With further miniaturization of the optical transceiver, an interval between a plurality of conductors for transmitting electrical signals between the substrate and the optical transceiver is narrowed. Accordingly, in order to ensure electrical connection between the plurality of conductors provided on the substrate and the plurality of conductors provided on the optical transceiver, it is required to improve positioning accuracy between the substrate and the optical transceiver.

There is a need for an improved novel optical device and optical transceiver capable of more reliably securing electrical connection between the substrate of the optical device and the optical transceiver.

According to one aspect of the present disclosure, there is provided an optical device including: a first substrate including a first surface facing a first direction and intersecting with the first direction; an optical transceiver provided to be shifted from the first substrate in the first direction; a socket positioned between the first substrate and the optical transceiver and including a plurality of connection conductors electrically connecting a conductor of the first substrate and a conductor of the optical transceiver, and an insulator supporting the plurality of connection conductors; and a positioning pin extending in the first direction between the first substrate and the optical transceiver and penetrating the socket, the positioning pin being configured to position the first substrate, the optical transceiver, and the socket in a direction intersecting with the first direction.

According to another aspect of the present disclosure, there is provided an optical transceiver for being applied to an optical device including: a first substrate including a first surface facing a first direction and intersecting with the first direction; the optical transceiver provided to be shifted from the first substrate in the first direction; a socket positioned between the first substrate and the optical transceiver and including a plurality of connection conductors electrically connecting a conductor of the first substrate and a conductor of the optical transceiver, and an insulator supporting the plurality of connection conductors; and a positioning pin extending in the first direction between the first substrate and the optical transceiver and penetrating the socket, the positioning pin being configured to position the first substrate, the optical transceiver, and the socket in a direction intersecting with the first direction, the optical transceiver including a positioning opening in which the positioning pin is positioned.

### BRIEF DESCRIPTION OF THE DRAWINGS

FIG. 1 is an exemplary schematic perspective view of a switch device of an embodiment;

FIG. 2 is an exemplary schematic plan view of the switch device of the embodiment;

FIG. 3 is an exemplary schematic side view of a part of the switch device of the embodiment;

FIG. 4 is a cross-sectional view taken along line IV-IV of FIG. 2;

FIG. 5 is an exemplary schematic plan view of a part of the switch device of the embodiment, and is a diagram illustrating a state before an optical transceiver is mounted, a state in which the optical transceiver is mounted, and a state in which the optical transceiver is mounted;

FIG. 6 is an exemplary schematic perspective view of the optical transceiver of the embodiment;

FIG. 7 is an exemplary schematic exploded perspective view of the optical transceiver of the embodiment;

FIG. 8 is a cross-sectional view taken along line VIII-VIII of FIG. 5; and

FIG. 9 is an exemplary schematic plan view of a bottom surface of the optical transceiver of the embodiment.

### DETAILED DESCRIPTION

Hereinafter, a plurality of exemplary embodiments will be disclosed. The configurations of the embodiments described below, and the functions and results (effects) provided by the configurations are examples. The present disclosure may also be realized by configurations other than those disclosed in the following embodiments. In addition, according to the present disclosure, it is possible to obtain at least one of various effects (including derivative effects) obtained by the configuration.

A plurality of embodiments described below have similar configurations. Therefore, according to the configuration of each embodiment, similar actions and effects based on the similar configuration may be obtained. In addition, in the following description, similar reference numerals are given to similar configurations, and redundant description may be omitted.

In the present specification, ordinal numbers are given for convenience in order to distinguish components, members, parts, directions, and the like, and do not indicate priority or order, and do not limit the number or the like.

In each drawing, an arrow X indicates an X direction, an arrow Y indicates a Y direction, and an arrow Z indicates a Z direction. The X direction, the Y direction, and the Z direction intersect each other and are orthogonal to each other.

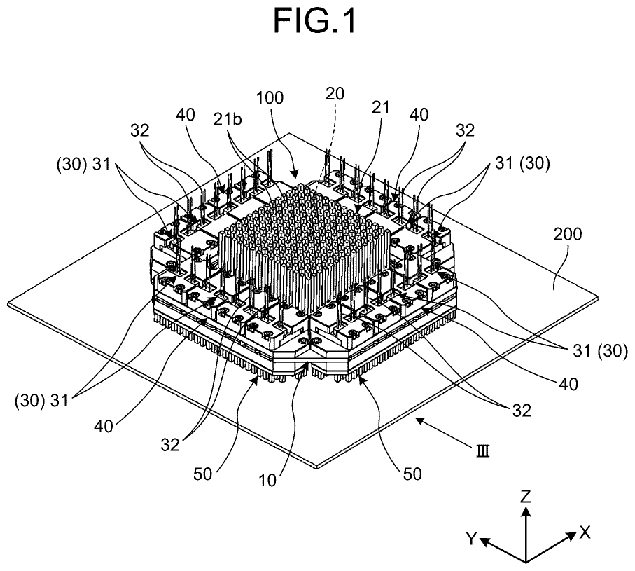

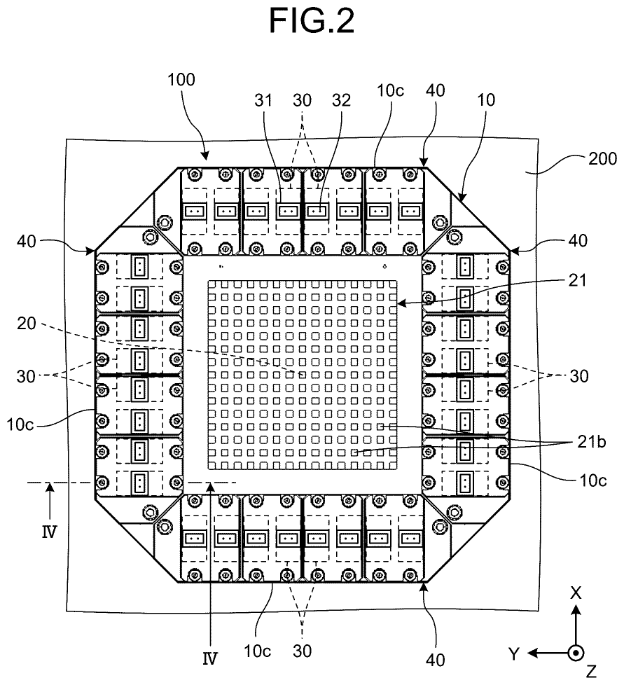

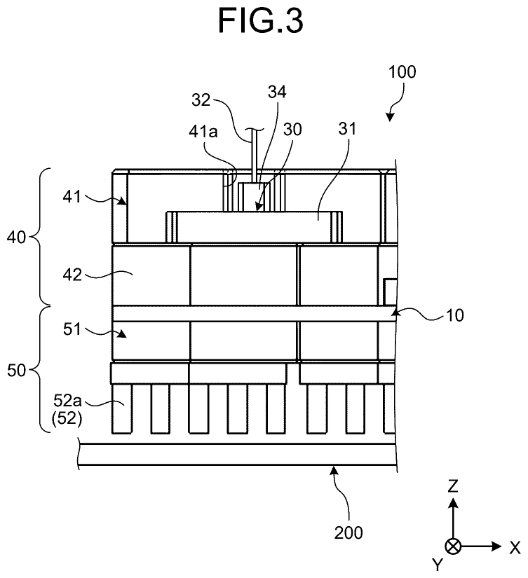

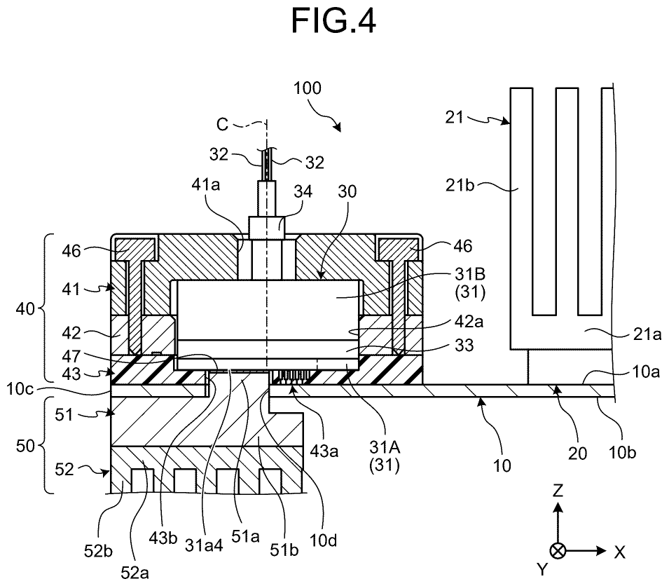

FIG. 1 is a perspective view of a switch device 100 of an embodiment. FIG. 2 is a plan view of the switch device 100. FIG. 3 is a side view of a part of the switch device 100 as viewed in the Y direction indicated by arrow III in FIG. 1. FIG. 4 is a cross-sectional view taken along line IV-IV of FIG. 2.

As illustrated in FIG. 1, the switch device 100 is mounted on a motherboard 200. In the present embodiment, only one switch device 100 is mounted on the motherboard 200, but a plurality of switch devices 100 may be mounted on the motherboard 200. The motherboard 200 may also be referred to as an integrated board. The switch device 100 is an example of an optical device.

As illustrated in FIGS. 1 and 2, the switch device 100 includes a substrate 10, a switch ASIC 20, a plurality of optical transceivers 30, a heat sink 21 for the switch ASIC 20, a fixing mechanism 40 for fixing the optical transceiver 30 to the substrate 10, and a heat dissipation mechanism 50 for the optical transceiver 30. In the switch device 100, the substrate 10, the fixing mechanism 40, and the heat dissipation mechanism 50 are referred to as a substrate assembly. The substrate assembly is mountable on the motherboard 200.

As illustrated in FIG. 2, the substrate 10 has four sides 10c extending in the X direction or the Y direction. In addition, as illustrated in FIG. 4, the substrate 10 includes a surface 10a that intersects with and extends orthogonally to the Z direction, has a plate shape, and faces the Z direction, and a surface 10b that faces the opposite direction of the Z direction on the opposite side of the surface 10a. The surfaces 10a and 10b intersect with the Z direction and extend orthogonally. The substrate 10 is, for example, a printed wiring board. The Z direction is an example of a first direction of the substrate 10 and may also be referred to as a thickness direction of the substrate 10. The substrate 10 is an example of a first substrate, and the surface 10a is an example of a first surface.

As illustrated in FIG. 2, the plurality of optical transceivers 30 are disposed along the four sides 10c of the substrate 10. Each of the optical transceivers 30 includes a photodiode array as a light receiving unit that receives an optical signal. Each of the light receiving units receives an optical signal transmitted through an optical fiber 32 and outputs an electric signal corresponding to the optical signal. The electrical signal is input to the switch ASIC 20 via a socket 43 (refer to FIG. 4) and a conductor provided on the substrate 10. The optical transceiver 30 also includes an electronic component that operates when outputting an electrical signal corresponding to the received optical signal.

In addition, each of the optical transceivers 30 includes, for example, a vertical cavity surface emitting laser (VCSEL) array as a light emitting unit that outputs an optical signal. Each of the light emitting units receives an electric signal from the switch ASIC 20 via a conductor provided on the substrate 10 and the socket 43, and outputs an optical signal corresponding to the electric signal. The optical signal is coupled to the optical fiber 32 and transmitted through the optical fiber 32. The optical transceiver 30 also includes an electronic component that operates when outputting an optical signal corresponding to the received electric signal.

As illustrated in FIGS. 1 and 2, the plurality of optical transceivers 30 are fixed to the substrate 10 by a fixing mechanism 40 provided for each side 10c of the substrate 10. The fixing mechanism 40 is provided for each of the four sides 10c, that is, a total of four, and is shared by a plurality of (eight in the present embodiment as an example) optical transceivers 30 arranged along each side 10c. As described above, since the fixing mechanism 40 is shared by the plurality of optical transceivers 30, for example, as compared with a case where the optical transceivers 30 are fixed to the substrate 10 by the respective fixing mechanisms, it is possible to obtain an advantage that it is possible to further simplify an attachment structure of the fixing mechanism 40 to the substrate 10, to further reduce the number of components, and to suppress the trouble and cost of manufacturing the switch device 100.

As illustrated in FIGS. 1 and 2, the switch ASIC 20 is mounted on the substrate 10 at a position (in the present embodiment, a substantially central portion of the substrate 10 as an example) farther away from each side 10c of the substrate 10 than the optical transceiver 30. Furthermore, as illustrated in FIG. 4, the switch ASIC 20 is flip-chip mounted on the surface 10a, for example. The switch ASIC 20 controls operation of each optical transceiver 30. The switch ASIC 20 is an example of a semiconductor integrated circuit.

As illustrated in FIG. 4, the heat sink 21 is provided so as to be in contact with the switch ASIC 20 on the side opposite to the substrate 10. The heat sink 21 is in contact with the top surface of the switch ASIC 20, and includes a base 21a and a plurality of fins 21b in an array shape and a pin shape protruding from the base 21a in the Z direction. The heat sink 21 is made of a material having a relatively high thermal conductivity, such as an aluminum-based metal material. With such a configuration, the heat generated in the switch ASIC 20 is transferred in the Z direction in the heat sink 21, and is transferred to the surrounding gas, that is, released by heat exchange between the fin 21b and the surrounding gas of the fin 21b.

As illustrated in FIGS. 3 and 4, in the present embodiment, as an example, the fixing mechanism 40 includes an upper member 41, an intermediate member 42, and the socket 43. The components of the fixing mechanism 40 are integrated by a fixture 46 such as a screw. Among the components of the fixing mechanism 40, the intermediate member 42 and the socket 43 are shared by all the optical transceivers 30 in the group of the plurality of optical transceivers 30 along each side 10c of the substrate 10. As illustrated in FIG. 4, the fixing mechanism 40 fixes the optical transceiver 30 positioned in the vicinity of the side 10c of the substrate 10 to the substrate 10 so as to sandwich the optical transceiver 30 in the thickness direction of the substrate 10.

In addition, in order to enable replacement after attachment of the optical transceiver 30, the fixing mechanism 40 detachably fixes the optical transceiver 30 to the substrate 10. In order to realize this, in the present embodiment, the components of the fixing mechanism 40 include components fixed to the substrate 10 and components detachable from the substrate 10. In the present embodiment, the intermediate member 42 and the socket 43 are fixed to the substrate 10, and the upper member 41 is configured to be attachable to and detachable from the intermediate member 42, that is, the substrate 10. Specifically, as illustrated in FIG. 4, the upper member 41 is attached to the intermediate member 42 by the fixture 46 configured as a removable screw.

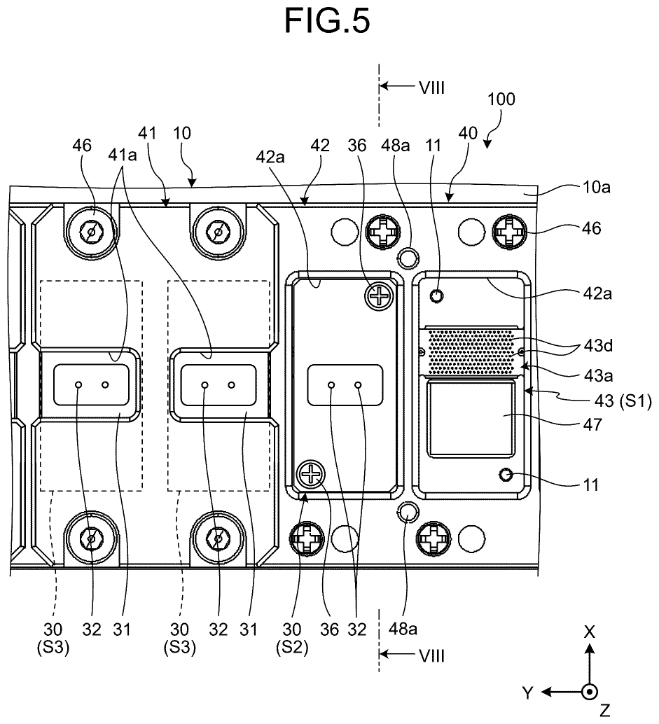

FIG. 5 is a plan view illustrating a state S1 before the optical transceiver 30 is mounted, a state S2 in which the optical transceiver 30 is mounted, and a state S3 in which the optical transceiver 30 is mounted. As illustrated in the state S3 of FIG. 5, in the present embodiment, the upper member 41 is not shared by all of the plurality of optical transceivers 30 along the side 10c, but is shared by only two optical transceivers 30 adjacent along the side 10c. As a result, for example, it is possible to achieve both facilitation of individual removal of the optical transceiver 30 and sharing of components, and it is possible to further improve positioning accuracy by reducing the influence of deflection of the fixing mechanism 40 and manufacturing variations of the components of the fixing mechanism 40, the optical transceiver 30, and the like. However, such a configuration is an example, and the upper member 41 may be shared by all of the plurality of optical transceivers 30 along the side 10c.

As illustrated in FIG. 4, the socket 43, the intermediate member 42, and the upper member 41 are placed on the substrate 10 in this order. In addition, the optical transceiver 30 is provided to be shifted in the Z direction with respect to the substrate 10.

The upper member 41 presses a body 31 of the optical transceiver 30 in a direction opposite to the Z direction toward the substrate 10 and the socket 43. As illustrated in FIGS. 4 and 5, the upper member 41 is provided with an opening 41a as a notch penetrating the upper member 41 in the Z direction. A part of the body 31 is accommodated in the opening 41a.

The intermediate member 42 is provided with an opening 42a as a through hole extending in the Z direction. The side surface of the opening 42a has a function of roughly guiding in the X direction and the Y direction when the body 31 of the optical transceiver 30 is mounted.

The socket 43 is placed on the surface 10a of the substrate 10 and supports the body 31 of the optical transceiver 30. The socket 43 is provided with an electrical interface 43a and an opening 43b. At least the electrical interface 43a of the socket 43 is located between the substrate 10 and the optical transceiver 30.

A conductor of the electrical interface 43a is electrically connected to a conductor of an electrical interface provided on a substrate 33 of the optical transceiver 30.

The opening 43b exposes a lower surface 31a4 provided in the body 31 of the optical transceiver 30 in a direction opposite to the Z direction. The opening 43b is provided as, for example, a through hole or a notch penetrating the socket 43 in the Z direction.

The heat dissipation mechanism 50 releases heat generated in the optical transceiver 30. The heat dissipation mechanism 50 includes a heat conduction member 51 and a heat sink 52. At least the heat conduction member 51 of the heat dissipation mechanism 50 may function as a part of the fixing mechanism 40.

The heat conduction member 51 is aligned with the optical transceiver 30 in the Z direction. The heat conduction member 51 includes a portion 51a accommodated in the opening 43b of the socket 43 and an opening 10d of the substrate 10, and a portion 51b located on the side opposite to the optical transceiver 30 with respect to the portion 51a. The heat conduction member 51 is thermally connected to the lower surface 31a4 of the optical transceiver 30, and transfers heat generated in the optical transceiver 30. The heat conduction member 51 is made of, for example, a material having a relatively high thermal conductivity such as an aluminum-based metal material. In addition, the heat conduction member 51 is fixed to the substrate 10 or the fixing mechanism 40 by a fixture such as a screw, adhesion, or the like.

The portion 51a is adjacent to the lower surface 31a4 via a flexible heat dissipation material 47 and is thermally connected to the lower surface 31a4. The heat dissipation material 47 is made of a synthetic resin material having relatively high thermal conductivity and flexibility, for example, a thermosetting synthetic resin material having high heat dissipation. By providing the heat dissipation material 47, it is possible to obtain advantages that it is possible to suppress a decrease in thermal conduction efficiency from the lower surface 31a4 to the portion 51a due to generation of a gap between the lower surface 31a4 and the portion 51a due to manufacturing variations, a difference in thermal expansion coefficient between components, and the like, and it is possible to suppress generation of an excessive pressing force between the lower surface 31a4 and the portion 51a.

The portion 51b is provided integrally with the portion 51a and is thermally connected to the portion 51a. The portion 51b extends from the portion 51a in the direction opposite to the Z direction, that is, in the thickness direction of the substrate 10, and extends in the direction intersecting the Z direction on the side opposite to the optical transceiver 30 with respect to the substrate 10.

The heat conduction member 51 is in contact with the heat sink 52 on the side opposite to the lower surface 31a4 with respect to the substrate 10, and is thermally connected to the heat sink 52. The heat sink 52 includes a base 52a and a plurality of pin-shaped fins 52b protruding from the base 52a in a direction opposite to the Z direction. The heat sink 52 is made of a material having a relatively high thermal conductivity, such as an aluminum-based metal material. In addition, the heat sink 52 is fixed to the heat conduction member 51 by the fixture such as a screw, soldering, adhesion, or the like. The heat conduction member 51 and the heat sink 52 may be integrated as one member. The heat sink 52 may also be referred to as a heat dissipation member.

By the heat conduction member 51 and the heat sink 52 having such a configuration, heat generated in the optical transceiver 30 is transferred from the lower surface 31a4 in a direction opposite to the Z direction in the heat conduction member 51 and the heat sink 52, and is transferred to, that is, released from the surrounding gas by heat exchange between the fin 52b and the surrounding gas of the fin 52b. The switch device 100 may include an electric fan, and an air flow generated by the operation of the electric fan may act on the heat sink 52.

Further, as is clear from FIG. 4, the lower surface 31a4 and the portion 51a are located on the side opposite to the switch ASIC 20 with respect to the electrical interface 43a. In addition, the electrical interface 43a is provided at a position closer to the switch ASIC 20 than a center line C extending in the Z direction of the body 31 of the optical transceiver 30. With such an arrangement, for example, it is possible to obtain advantages that a length of a conductor between the electrical interface 43a and the switch ASIC 20 may be further shortened, so that required transmission characteristics of an electrical signal may be easily secured, and interference between the heat conduction member 51 and the conductor may be avoided, so that required heat dissipation performance from the optical transceiver 30 may be easily obtained.

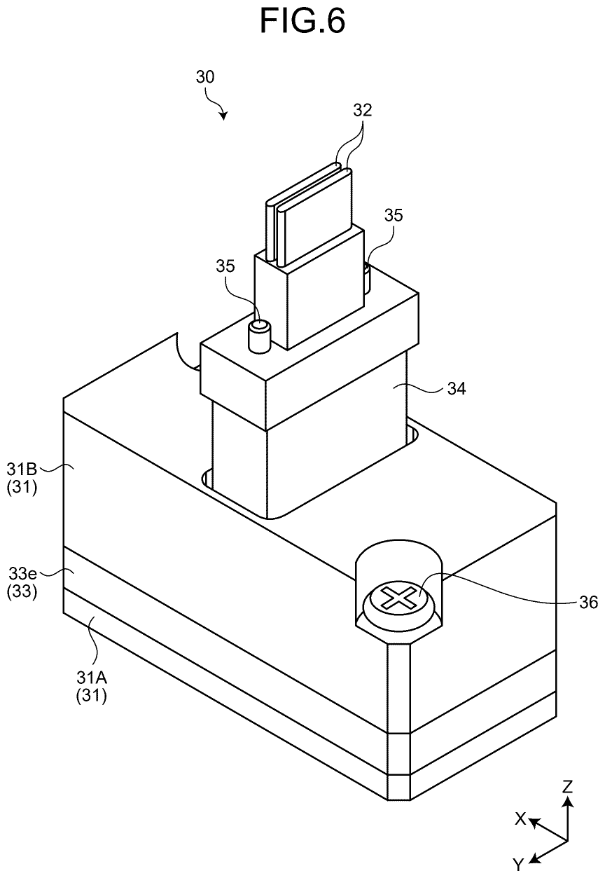

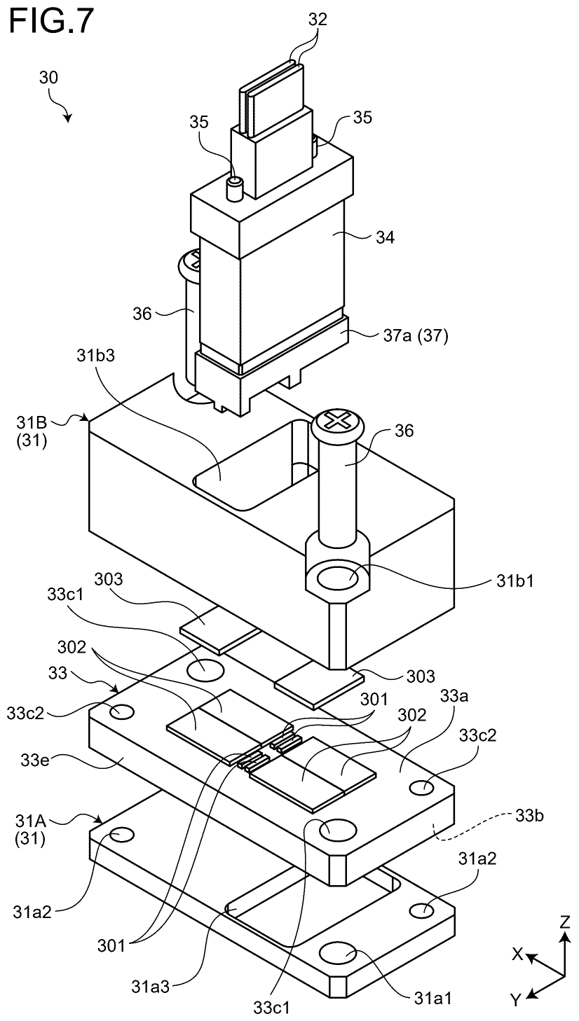

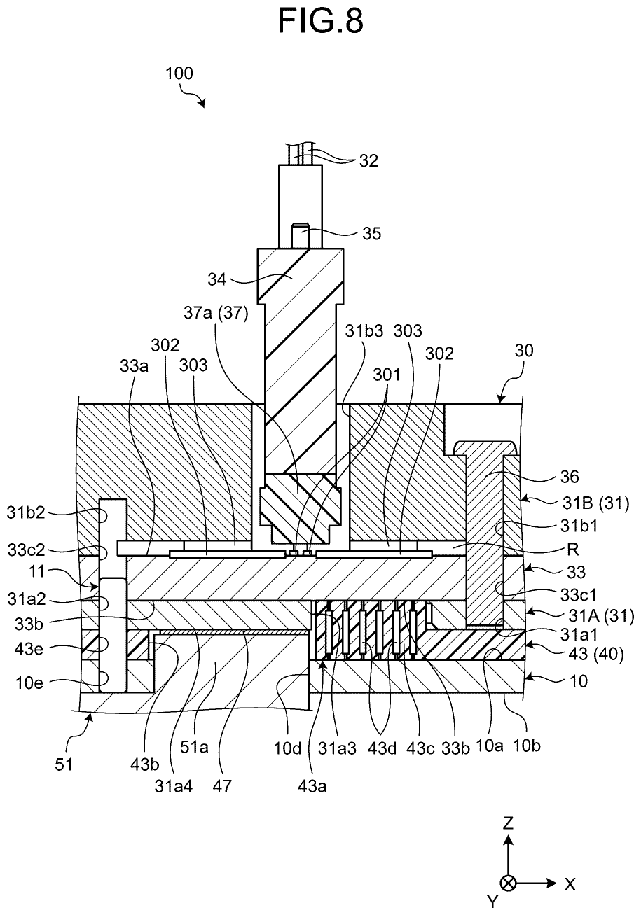

FIG. 6 is a perspective view of the optical transceiver 30. FIG. 7 is an exploded perspective view of the optical transceiver 30. In addition, FIG. 8 is a cross-sectional view taken along line VIII-VIII of FIG. 5. FIGS. 6 to 8 illustrate directions (X direction to Z direction) in a state where the optical transceiver 30 (S2) illustrated in FIG. 5 is mounted.

As illustrated in FIGS. 6 and 7, the optical transceiver 30 includes the body 31, the substrate 33, a connector 34, a positioning pin 35, and a fixture 36. The optical fiber 32 extends from the optical transceiver 30 in the Z direction. A first member 31A constituting the body 31 and the substrate 33, and a second member 31B constituting the body 31 are arranged in this order in the Z direction, and are integrated by the fixture 36. The fixture 36 is, for example, a screw. The fixture 36 is an example of a coupler. The body 31 may also be referred to as a housing.

A peripheral edge portion 33e of the substrate 33 is exposed between the first member 31A and the second member 31B constituting the body 31, and constitutes a part of the outer surface of the optical transceiver 30 together with the first member 31A and the second member 31B. With such a configuration, the size of the optical transceiver 30 may be further reduced as compared with a case where the substrate 33 is accommodated in the body 31.

As illustrated in FIGS. 7 and 8, a lens assembly 37 is attached to the connector 34 so as to be adjacent in the opposite direction of the Z direction. The lens assembly 37 includes a holder 37a and a lens array such as a collimating lens array or a condenser lens array attached to the holder 37a. The positioning pin 35 positions the connector 34 and the lens assembly 37 in a direction intersecting with the Z direction.

The second member 31B has a substantially rectangular parallelepiped shape. The second member 31B is provided with an opening 31b3 at an intermediate portion in the X direction. The opening 31b3 penetrates the second member 31B in the Z direction. At least a part of the connector 34 and the lens assembly 37 is accommodated in the opening 31b3 of the second member 31B.

The second member 31B is provided with through holes 31b1 penetrating in the Z direction at a plurality of positions. The substrate 33 is provided with through holes 33cl penetrating in the Z direction so as to be aligned with the through hole 31b1 in the Z direction, and the first member 31A is provided with a female screw hole 31al. The fixture 36 passes through the through hole 31b1 and the through hole 33cl and is fixed to the female screw hole 31a1.

The substrate 33 is, for example, a printed wiring board. The substrate 33 has a substantially constant thickness in the Z direction, and intersects with and is orthogonal to the Z direction. The substrate 33 includes a surface 33a and a surface 33b.

The surface 33a faces the Z direction and intersects with and is orthogonal to the Z direction. An optical element 301, an electronic component 302, and the like are mounted on the surface 33a. The optical element 301 is, for example, a light receiving unit such as a photodiode array or a light emitting unit such as a VCSEL array. Furthermore, the electronic component 302 is, for example, an IC that operates corresponding to the light receiving unit and the light emitting unit.

The surface 33b faces the opposite direction of the Z direction and intersects with and is orthogonal to the Z direction. The surface 33b faces the electrical interface 43a of the socket 43. The substrate 33 is an example of a second substrate, and the surface 33b is an example of a second surface.

As illustrated in FIG. 8, a recess recessed in the Z direction is provided in a portion facing a mounting region of the optical element 301 and the electronic component 302 in an end portion of the second member 31B in the opposite direction to the Z direction. With such a configuration, a housing chamber R for components such as the optical element 301 and the electronic component 302 is provided between the substrate 33 and the second member 31B. The recess may be provided in a portion of the substrate 33 facing the second member 31B.

The electronic component 302 generates heat according to the operation. The electronic component 302 is an example of a heating element. In order to dissipate heat generated in the electronic component 302, two heat dissipation paths are provided in the present embodiment.

One of the heat dissipation paths is a path for releasing heat from the first member 31A to the heat conduction member 51 of the heat dissipation mechanism 50 described above. In this case, the heat generated in the electronic component 302 is transferred from the surface 33b of the substrate 33 to the first member 31A. In the substrate 33, for example, the heat conduction member, such as a via or inlay at a ground potential, which conducts heat generated by the electronic component 302 mounted on the surface 33a to the surface 33b may be provided. The heat conduction member is made of, for example, a material having a higher thermal conductivity than the insulator of the substrate 33, such as a copper-based metal material. In addition, the first member 31A is made of a material having a relatively high thermal conductivity, such as an aluminum-based metal material, and having a thermal conductivity higher than that of the insulator of the substrate 33.

The other of the heat dissipation paths is a path for releasing heat from the electronic component 302 to the second member 31B via a heat dissipation material 303 provided between the electronic component 302 and the second member 31B. The heat dissipation material 303 is made of a thermally conductive sheet (for example, a graphite sheet) having relatively high thermal conductivity and flexibility or a synthetic material containing silicone as a main component. The heat dissipation material 303 is an example of a heat conduction member. In addition, the second member 31B is made of a material having a relatively high thermal conductivity, such as an aluminum-based metal material, and having a thermal conductivity higher than that of the insulator of the substrate 33.

The heat transferred to the first member 31A or the second member 31B through these heat dissipation paths is dissipated to the outside of the switch device 100 through the heat dissipation mechanism 50, the fixing mechanism 40, and the like.

As illustrated in FIGS. 7 and 8, the first member 31A has a substantially constant thickness in the Z direction, and intersects with and is orthogonal to the Z direction. The first member 31A is provided with an opening 31a3 penetrating in the Z direction at an intermediate portion in the X direction.

As illustrated in FIG. 8, the electrical interface 43a of the socket 43 penetrates the opening 31a3. The socket 43 includes an insulator 43c and a plurality of connection conductors 43d. The insulator 43c supports the plurality of connection conductors 43d. Each of the connection conductors 43d penetrates the socket 43 in the Z direction in the electrical interface 43a and electrically connects the conductor of the substrate 33 and the conductor of the substrate 10. The connection conductor 43d may be configured as, for example, a contact terminal having an elastically stretchable pin extending in the Z direction. In such a configuration, the conductor of the electronic component 302 is electrically connected to the conductor of the switch ASIC 20 via the conductor of the substrate 33 of the optical transceiver 30, the connection conductor 43d, and the conductor of the substrate 10. By providing the socket 43 having the electrical interface 43a, for example, as compared with a case where the electrical interface is directly provided on the substrate 10, it is possible to obtain an advantage that a configuration capable of securing required positioning accuracy between the conductor of the substrate 33 of the detachable optical transceiver 30 and the conductor of the substrate 10 may be more easily constructed. In addition, by configuring the connection conductor 43d as a contact terminal having an extendable pin, it is possible to obtain an advantage that it is easy to secure a required surface pressure and a required contact area between the conductor of the substrate 33 and the connection conductor 43d and between the conductor of the substrate 10 and the connection conductor 43d, and an increase in contact resistance may be suppressed.

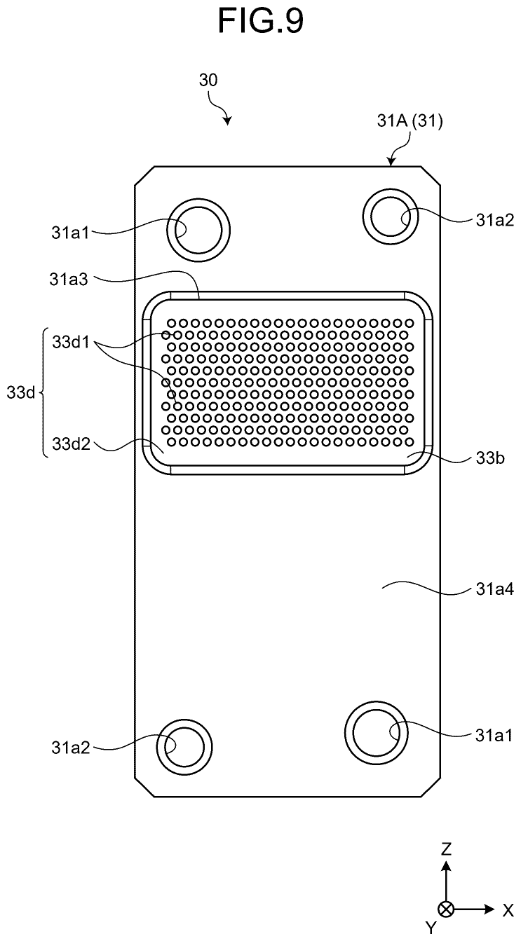

FIG. 9 is a plan view of a lower surface 31a4 located in a direction opposite to the Z direction of the optical transceiver 30. FIG. 9 also illustrates directions (X direction to Z direction) in a state where the optical transceiver 30 (S2) illustrated in FIG. 5 is mounted.

As illustrated in FIG. 9, at an end portion of the optical transceiver 30 in a direction opposite to the Z direction, a region of the surface 33b of the substrate 33 where an electrical interface 33d is provided is exposed through the opening 31a3 provided in the first member 31A. The electrical interface 33d includes a plurality of lands 33d1 and an insulator 33d2. Each of the lands 33d1 is in contact with and electrically connected to the connection conductor 43d of the socket 43 in the Z direction. The land 33d1 is an example of a conductor.

Here, as illustrated in FIG. 9, the plurality of lands 33d1 constitute a land grid array. In the land grid array illustrated in FIG. 9, the rows of the lands 33d1 in which the plurality of lands 33d1 are arranged at regular intervals in the Y direction are arranged at substantially regular intervals in the X direction. Further, the positions of the rows of the two lands 33d1 adjacent to each other in the X direction are shifted by, for example, about a half of the interval between the lands 33d1 in the Y direction. That is, in the land grid array, the plurality of lands 33d1 are arranged in a rhombic lattice shape. With such an arrangement, more lands 33d1 may be arranged more densely, so that the optical transceiver 30 may be configured to be smaller. As described above, the plurality of lands 33d1 are arranged as the land grid array in a case where the interval between the lands 33d1 is preferably 0.6 [mm] or less, and more preferably 0.3 [mm] or less.

As illustrated in the socket 43 (S1) in FIG. 5, the plurality of connection conductors 43d electrically connected in contact with the plurality of lands 33d1 also form a land grid array similarly to the plurality of lands 33d1.

In order to ensure such electrical connection between the plurality of conductors of the substrate 10 and the lands 33d1 as the plurality of conductors of the substrate 33, which are arranged at narrow intervals, it is necessary to accurately position the substrate 10, the socket 43, and the substrate 33 in a direction intersecting with the Z direction.

Therefore, in the present embodiment, as illustrated in FIG. 8, the substrate 10, the socket 43, and the substrate 33 are positioned in a direction intersecting with the Z direction by a positioning pins 11 extending in the Z direction.

Specifically, the substrate 10 is provided with a through hole 10e penetrating in the Z direction. The socket 43 is provided with a through hole 43e penetrating in the Z direction. The substrate 33 is provided with a through hole 33c2 penetrating in the Z direction. The through hole 10e, the through hole 43e, and the through hole 33c2 are arranged in the Z direction, and extend in the Z direction with substantially the same diameter. The first member 31A is provided with a through hole 31a2 penetrating in the Z direction, and is aligned in the Z direction with the through holes 10e, 43e, and 33c2. The positioning pin 11 penetrates the through hole 43e and the through hole 31a2 and extends between the through hole 10e and the through hole 33c2. The fitting between the positioning pin 11 and the through holes 10e, 43e, 31a2, and 33c2 is set to be, for example, an intermediate fit or a clearance fit. With such a configuration, the substrate 10, the socket 43, the first member 31A, and the substrate 33 are positioned in a direction intersecting the Z direction by the positioning pins 11. When the optical transceiver 30 is positioned by the positioning pin 11 in the through hole 33c2 provided in the substrate 33, the through hole 31a2 of the first member 31A is not necessarily positioned with the positioning pin 11. In this case, the through hole 31a2 may be a through hole having a larger clearance from the positioning pin 11, in other words, not positioned with the positioning pin 11, a notch, or the like. The through hole 31a2 is an example of a first opening, and the through hole 33c2 is an example of a second opening. The through holes 10e, 43e, 31a2, and 33c2 are examples of positioning openings.

Further, in the present embodiment, as illustrated in FIG. 8, the second member 31B is provided with a bottomed hole 31b2 extending in the Z direction from a position in contact with the substrate 33. The bottomed hole 31b2 is aligned with the through holes 31a2 and 33c2 in the Z direction, and extends in the Z direction with substantially the same diameter as the through holes 31a2 and 33c2. In this case, when the optical transceiver 30 is assembled, the first member 31A, the substrate 33, and the second member 31B may be positioned in a direction intersecting the Z direction by using a positioning pin that penetrates the through holes 31a2 and 33c2 and is inserted into the bottomed hole 31b2. The bottomed hole 31b2 is an example of the third opening. The third opening is not limited to the bottomed hole 31b2, and may be a through hole.

As illustrated in FIGS. 5 and 9, in the present embodiment, the positioning pin 11 and the through holes 10e, 43e, 31a2, and 33c2 through which the positioning pin 11 passes are provided at a plurality of positions separated from each other in the direction intersecting with the Z direction. In plan view as viewed in the Z direction, the electrical interfaces 43a and 33d, that is, the plurality of connection conductors 43d and the plurality of lands 33d1 are provided at positions between the plurality of locations. As a result, the plurality of connection conductors 43d and the plurality of lands 33d1 may be positioned more accurately.

As described above, according to the present embodiment, it is possible to obtain the improved and novel switch device 100 and optical transceiver 30 that enable more reliable electrical connection between the substrate 10 of the switch device 100 (optical device) and the optical transceiver 30.

Although the embodiments have been exemplified above, the above embodiments are merely examples, and are not intended to limit the scope of the disclosure. The above-described embodiments may be implemented in various other forms, and various omissions, substitutions, combinations, and changes may be made without departing from the gist of the disclosure. In addition, specifications (structure, type, direction, model, size, length, width, thickness, height, number, arrangement, position, material, and the like) of each configuration, shape, and the like may be appropriately changed and implemented.

For example, the optical transceiver and the positioning pin may be positioned at a portion other than the second substrate of the optical transceiver, for example, at the first opening.

Further, in the above embodiment, a peripheral edge portion of the second substrate of the optical transceiver is exposed as a part of the outer surface of the optical transceiver, but the present disclosure is not limited thereto, and the second substrate may be accommodated in the body (housing) of the optical transceiver, and the peripheral edge portion may not be exposed to the outer surface.

According to the present disclosure, for example, it is possible to obtain an improved novel optical device and optical transceiver capable of more reliably securing electrical connection between the substrate of the optical device and the optical transceiver.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical device comprising:
a first substrate including a first surface facing a first direction and intersecting with the first direction;
an optical transceiver provided to be shifted from the first substrate in the first direction;
a socket positioned between the first substrate and the optical transceiver and including a plurality of connection conductors electrically connecting a conductor of the first substrate and a conductor of the optical transceiver, and an insulator supporting the plurality of connection conductors; and
a positioning pin extending in the first direction between the first substrate and the optical transceiver and penetrating the socket, the positioning pin being configured to position the first substrate, the optical transceiver, and the socket in a direction intersecting with the first direction.

2. The optical device according to claim 1, wherein the optical transceiver includes:
a second substrate including a plurality of conductors and an insulator; and
a first member provided between the first substrate and the second substrate and including a first opening into which the positioning pin is inserted.

3. The optical device according to claim 2, wherein
the first opening penetrates the first member,
the positioning pin penetrates the first opening,
a second opening into which the positioning pin is inserted is provided in the second substrate, and
the optical transceiver is positioned with the positioning pin in the second opening.

4. The optical device according to claim 3, wherein the optical transceiver includes a second member configured to cover the second substrate on a side opposite to the first member with respect to the second substrate.

5. The optical device according to claim 4, wherein the second member is provided with a third opening aligned with the second opening in the first direction.

6. The optical device according to claim 4, wherein the optical transceiver includes a coupler configured to integrate the first member and the second member.

7. The optical device according to claim 4, wherein the optical transceiver includes:
a heating element provided on the second substrate; and
a heat conduction member interposed between the heating element and the first member or the second member.

8. The optical device according to claim 7, wherein the heat conduction member has flexibility.

9. The optical device according to claim 2, wherein
the second substrate includes a second surface facing the socket in a direction opposite to the first direction, and
the plurality of conductors of the second substrate constitute a land grid array on the second surface.

10. The optical device according to claim 9, wherein the plurality of conductors of the second substrate are arranged in a rhombic lattice shape on the second surface.

11. The optical device according to claim 9, wherein the plurality of conductors of the second substrate are arranged at an interval of 0.6 mm or less on the second surface.

12. The optical device according to claim 1, wherein the optical transceivers include a plurality of optical transceivers.

13. The optical device according to claim 12, wherein the plurality of optical transceivers are disposed along a side of the first substrate.

14. The optical device according to claim 13, wherein
the plurality of optical transceivers are disposed along four sides of the first substrate, and
a semiconductor integrated circuit is mounted on the first surface at a position farther from each of the sides than the optical transceiver.

15. The optical device according to claim 14, wherein the plurality of connection conductors are provided at positions closer to the semiconductor integrated circuit than a center of the optical transceiver when viewed in the first direction.

16. The optical device according to claim 1, comprising an optical fiber extending from the optical transceiver in the first direction.

17. An optical transceiver for being applied to an optical device including: a first substrate including a first surface facing a first direction and intersecting with the first direction; the optical transceiver provided to be shifted from the first substrate in the first direction; a socket positioned between the first substrate and the optical transceiver and including a plurality of connection conductors electrically connecting a conductor of the first substrate and a conductor of the optical transceiver, and an insulator supporting the plurality of connection conductors; and a positioning pin extending in the first direction between the first substrate and the optical transceiver and penetrating the socket, the positioning pin being configured to position the first substrate, the optical transceiver, and the socket in a direction intersecting with the first direction, the optical transceiver comprising
a positioning opening in which the positioning pin is positioned.

18. The optical transceiver according to claim 17, comprising:
a second substrate including a plurality of conductors and an insulator; and
a first member provided between the first substrate and the second substrate and provided with a first opening into which the positioning pin is inserted.

19. The optical transceiver according to claim 18, wherein
the first opening penetrates the first member,
the positioning pin penetrates the first opening, and
the second substrate is provided with a second opening as the positioning opening.

20. The optical transceiver according to claim 18, comprising
a second member configured to cover the second substrate on a side opposite to the first member with respect to the second substrate, wherein
a part of an outer surface of the optical transceiver is constituted by the first member, the second member, and the second substrate.
